(19) United States
(12) Patent Application Publication
(10) Pub. No.: US 2008/0230528 A1
(43) Pub. Date: Sep. 25, 2008

(54) METHOD OF ELECTRIC ARC JOINING WITH ALTERNATING CURRENT

(76) Inventor: Gerald Wilhelm, Aichach (DE)

Correspondence Address: The BOC Group, Inc., 575 MOUNTAIN AVENUE, MURRAY HILL, NJ, 07974-2082, US

(21) Appl. No.: 12/043,405

(22) Filed: Mar. 6, 2008

(30) Foreign Application Priority Data
Mar. 22, 2007 (DE) 102007013801.8
Apr. 12, 2007 (DE) 102007017226.7
Aug. 28, 2007 (EP) 07016840.6

(51) Int. Cl. B23K 9/00

(52) U.S. Cl. 219/137 R

(57) ABSTRACT

The invention relates to a method for arc joining, in particular for arc welding, such that an arc burns between a workpiece and a fusible electrode at a processing site such that an alternating current with at least one positive alternating current phase and at least one negative alternating current phase is applied between the electrode and the workpiece such that the positive alternating current phase is divided into at least one positive pulsed current phase and at least one positive basic current phase and such that the arc is influenced at least temporarily by at least one external magnetic field. According to this invention, the arc is deflected at least temporarily out of the center of the processing site by one or more external magnetic fields during the positive pulsed current phase such that the arc is deflected into a first direction during a positive pulsed current phase and into a second direction which differs from the first direction during the next positive pulsed current phase.

### CROSS REFERENCE TO RELATED APPLICATIONS

This application claims priority from EP Patent Application No. 07016840.6, filed 28 Aug. 2007, which claims priority from DE Patent Application No. 102007017226.7 (filed 12 Apr. 2007) and DE Patent Application No. 102007013801.8 (filed 22 Mar. 2007).

### BACKGROUND OF THE INVENTION

The invention relates to a method for electric arc joining, in particular arc welding, wherein an arc burns between a workpiece and an electrode that is to be fused at a processing location such that an alternating current with at least one positive alternating current phase and at least one negative alternating current phase is applied between the electrode and the workpiece to generate the arc, such that the positive alternating current phase is divided into at least one positive pulsed current phase and at least one positive basic current phase and such that the arc is influenced at least temporarily by at least one external magnetic field.

For arc welding under a shielding gas, various welding methods are used for gas-shielded metal arc welding (GMA welding). In addition to the method using a fusible electrode, which also includes the metal-active gas and metal-inert gas welding, there is tungsten inert gas welding which does not work with a fusible electrode and also plasma welding. In gas-shielded metal arc soldering (GMA soldering), an integral bond is established due to the filler material. To do so, the filler material is fused in the arc and bonded to the base metal.

In arc welding with a fusible electrode, an electric arc burns between the fusible electrode and the workpiece. To generate the arc, an electric field is applied between the electrode and the workpiece. Transfer of material from the fusible electrode to the workpiece is accomplished by the drops detaching from the electrode. In addition to welding with a non-pulsating direct current, there is also welding with a pulsating direct current in which the welding current has at least one pulsed current phase and a basic current phase in which the current is definitely lower than in the pulsed current phase. Furthermore, there is also welding with an alternating current, in which the polarity alternates. In alternating current welding, the positive phase often has at least one pulsed current phase with a high current and a basic current phase with a low current.

Gas-shielded metal arc welding with an alternating current has been used for many years and various publications pertain to this process. DE 4023155 describes a synchronization of wire feed and the negative polarity of the alternating current. Again in DE 19906039, a maximum current level is set for the positive phase. EP 0890407 describes a procedure for reducing the drop time when the positive welding current drops. U.S. Pat. No. 6,376,802 describes a method which prevents an interruption in the arc. EP 1491278 discloses the use of helium and doped helium in the shielding gas in alternating current welding.

In addition to welding with a fusible electrode, gas-shielded metal arc soldering with a fusible electrode has been practiced for a long time. In this case, a wire electrode with a low melting point is used. The goal is a soldered joint with little or no fusion of the base metal. The latest developments also attempt to combine the two processes, e.g., joining aluminum workpieces to coated steel plates, such that a soldering process takes place toward only one side of the material while a welding process takes place toward the other side. All these processes are carried out with direct current, pulsed current or alternating current. Examples can be found in EP 1129808 or EP 1491278 or EP 1321218.

The term arc joining is understood to refer to the methods that work with electric arcs, i.e., joining welding as well as joining soldering and resurface welding as well as resurface soldering.

It is also known that the properties and position of the electric arc in welding can be influenced by external longitudinal or transverse magnetic fields. Means of influencing arc welding are described, e.g., in “Contribution Toward Arc Control by Transverse Auxiliary Magnetic Fields in Mechanized Arc Welding Methods” by U. Dilthey, Dissertation, RWTH Aachen (Technical Institute of Aachen) 1972 or in “Influencing Gas-Shielded Metal Arc Welding by Magnetic Fields” by H. B. Basler, Dissertation, TU Hannover (Technical University, Hannover) 1973. As part of an AIF project, the influence of its general magnetic fields was investigated, e.g., in the publication “MAGM High-Performance Welding With Solid and Filler Wires,” AIF project; concluding report AIF 103 68N; date of report: May 28, 1998, Institute for Technical Welding Finishing Methods of the Rhineland Westphalian Technical Institute of Aachen, Ulrich Dilthey, P. Warmuth, Technical Institute, ISF Aachen, 1998.

If an integral bond is established by welding or soldering, we also speak of joining welding or joining soldering. In joining welding/soldering, it is often necessary to bridge a gap in the root run. The base metal at the processing site fuses the filler welding material supplied by the fusible electrode onto and/or away from the base. The base metal fuses especially at the edges of the gap. In order for this to form a joint, the weld seam and/or soldered seam must not collapse but instead a joining weld must be formed from the molten weld pool. The problem of the seam collapse occurs in particular in welding and soldering root runs because there is not yet a layer present in the root run that can have a certain hold on the molten material at the processing site. With all the layers that follow the root run, the weld that is already present stabilizes the layer to be applied next. However, this stabilization may under some circumstances be too low, so the seam may collapse even as additional layers are being applied. The problems associated with seam collapse are observed even in thin sheet metal joining, especially in one-sided welded joints and with all welding tasks in which a gap must be bridged. These problems are especially pronounced at higher deposition rate.

In resurface welding or resurface soldering, however, material is applied to a workpiece. This method is used, for example, to repair worn components, to apply wear-resistant and/or corrosion-resistant edge layers or surface layers and for plating and reinforcing. The material is applied by welding, such that one or more layers are applied. In resurface welding and resurface soldering, a slight mixing effect is desired in order for the development of intermetallic phases to be suppressed as much as possible. In resurface soldering, there is a much lower mixing effect than in resurface welding, but here again an improvement would be desirable. In resurface welding and resurface soldering, many of the problems that become greater with an increase in the deposition rate can be attributed to the mixing effect that takes place.

### BRIEF SUMMARY OF THE INVENTION

The object of the invention is therefore to provide a method for arc joining with a fusible electrode and an alternating current, which will improve welding, broaden the possible applications and also allow high deposition rates. The method to be provided should in particular reduce the aforementioned problems in joining, in both joining welding and joining soldering as well as in resurface welding and resurface soldering.

This object is achieved according to this invention by the fact that the arc is deflected at least temporarily out of the center of the processing site by one or more external magnetic fields, at least during every fifth pulsed current phase, preferably during every second pulsed current phase, and especially preferably during each positive pulsed current phase, such that the arc is deflected into a first direction during a positive pulsed current phase and is deflected into a second direction which deviates from the first direction during the next positive pulsed current phase. Deflection of the arc out of the center of the processing site achieves the result that the arc does not burn in the gap or at the resurfacing site at least partially, preferably during the entire time of the positive pulsed-current phase in which the highest current is applied. Since the electric arc has an arc pressure that increases with an increase in the current value, the deflection of the arc during arc welding causes the high arc pressure not to act centrally at the processing site but instead to act at an adjacent site. At this point, the base metal is not molten but instead is solid or softens due to the effect of the heat. Therefore, the workpiece is better able to withstand the high arc pressure at this point. In arc soldering, it is also advantageous if the high arc pressure does not act at the center of the processing site.

However, if the high arc pressure acts centrally on the processing site, then the problems described above occur. With the inventive method, thus the collapse of the weld and/or the soldered seam is/are reduced and even prevented. The mixing effect is also optimized in resurface welding.

According to the present invention, during a positive pulsed-current phase, the arc is deflected in a first direction and during the next positive pulsed current phase, the arc is deflected into a second direction which is different from the first direction. This avoids a one-sided effect which can lead to asymmetrical processing.

It is especially advantageous that the first and second directions always alternate. It is also advantageous that the first and second directions are opposite one another.

It is advantageous in particular that the first and second directions are opposite one another. Such a deflection can be implemented with little effort and leads to symmetrical processing without any distortion of the direction of machining.

A transverse magnetic field is advantageously applied. By applying a transverse magnetic field, the deflection required in the present invention is achieved especially advantageously and the inventive advantages are established in particular.

The advantages of the present invention are manifested in a particularly pronounced manner when deposition rates of 6 to 15 kg/h, preferably 8 to 11 kg/h are used. At high deposition rates, especially high positive pulsed current values are required, so the arc pressure is especially high during the positive pulsed current phase at high deposition rates. Consequently, deflection of the arc is especially advantageous.

In an advantageous embodiment of the invention, a gap formed by two edges in the workpiece is to be bridged. In joining welding, the inventive advantages are manifested in particular. By eliminating the high arc pressure according to the present invention, blowout of molten base metal is suppressed, and collapse of the seam is prevented. In resurface welding and resurface soldering, the inventive method also yields advantages because the mixing effect can be influenced here in an especially advantageous manner.

It is especially advantageous here that the arc is always deflected alternately in the direction of one edge and in the direction of the other edge. Thus the deflected arc burns in the flank of the weld. The flank or edge is able to withstand the high arc pressure, yielding the advantages according to the present invention.

This invention offers special advantages in gas-shielded metal arc welding and gas-shielded metal arc soldering of root runs or one-sided joints, in particular in one-sided joints on thin metal plates. Such joints are especially susceptible to partial or complete collapse of the weld, which is counteracted by the inventive method.

Gases or gas mixtures containing at least argon, helium, carbon dioxide, oxygen and/or nitrogen are used to advantage as the shielding gas. The suitable gas and/or suitable gas mixture is determined as a function of the welding job, in particular taking into account the base metal and the filler material. Pure gases as well as two-component, three-component and multi-component mixtures may be used. In many cases, doped gas mixtures have also proven to be especially advantageous, such that doped gas mixtures contain doping with active gases in the vpm range, i.e., the doping is in the range of less than 1%, usually less than 0.1 vol %. Active gases such as oxygen, carbon dioxide, carbon monoxide, laughing gas (nitrous oxide) or nitrogen may be used as the doping gas.

The inventive method is suitable in particular when workpieces of steels and/or aluminum/aluminum alloys are processed. Therefore, this method is suitable in particular for all grades of steel, including structural steel, fine-grained structural steel and stainless steel. In addition it is also suitable for nickel-based materials. Likewise, this method may also be used with other nonferrous metals such as magnesium/magnesium alloys. In addition, the possibilities for production of mixed joints are also expanded through the inventive method.

### BRIEF DESCRIPTION OF THE DRAWINGS

FIG. 1 shows a schematic line showing the direction in which the deflected arc burns.

FIG. 2 illustrates a current waveform which may be used for the inventive method.

### DETAILED DESCRIPTION OF THE INVENTION

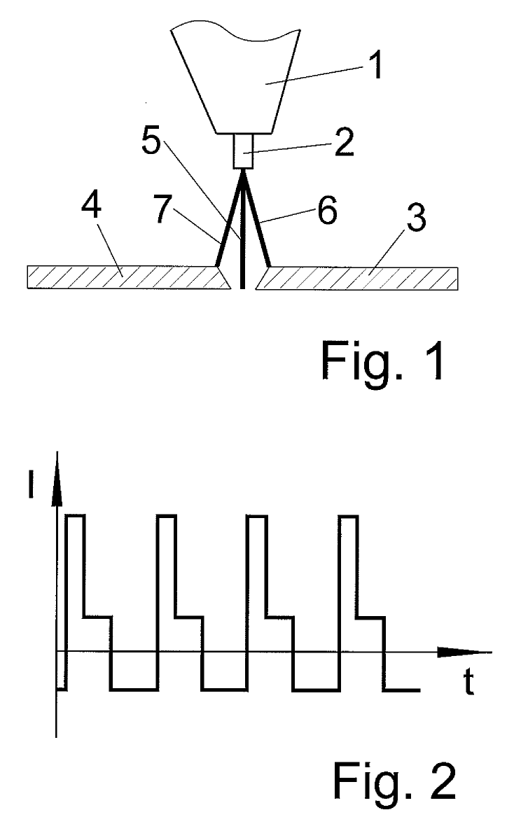

On the basis of FIGS. 1 and 2, the deflection of the arc in joining welding or joining soldering will now be explained in greater detail. The diagrams and dimensions in FIG. 1 are examples. FIG. 1 shows a welding torch 1 with a fusible electrode 2. Furthermore, FIG. 1 shows a workpiece in which a gap is to be bridged and a joint is to be created. The gap divides the workpiece into a right side 3 and a left side 4. Instead of the arc, FIG. 1 shows a schematic line situated at the center of the arc and thus showing the direction in which the arc burns. Without deflection, i.e., without applying an external magnetic field, the arc burns straight toward the workpiece. The direction of the arc thus follows line 5 here. According to the present invention, the arc is deflected out of the center of the molten weld pool to the right side 3 by an external magnetic field during a first positive pulsed current phase. The arc then burns in the direction of the right edge, i.e., in the flank of the weld. The arc is now pointing in direction 6. In the next positive pulsed current phase, the arc is deflected toward the left side 4 by an external magnetic field and burns in the direction of the left side. The direction of the arc thus follows the line 7. Deflection of the arc by a magnetic field is then accomplished only for the duration of the positive pulsed current phase at most. Otherwise, the arc burns straight in the direction of the workpiece as indicated with the help of line 5.

In resurface welding and resurface soldering, deflection is accomplished in the same way but the workpiece does not have a gap, so the weld line can be seen instead of the gap and the arc is deflected away from the weld line.

With the help of FIG. 2, the positive pulsed current phase in which the deflection is accomplished by means of an external magnetic field will now be described in greater detail. FIG. 2 illustrates a current waveform which may be used for the inventive method, for example. The current waveform according to FIG. 2 has positive and negative current values. The positive current values are applied during the positive phase. The positive phase is divided into a positive pulsed current phase during which a high positive current, the so-called pulsed current, is applied and a positive basic current phase during which a negative positive current is applied. The deflection is in the positive pulsed current phase. For example, if the arc is deflected to the right in the first of the positive pulsed current phases depicted here, then it is deflected to the left in the next positive pulsed current phase and is deflected back to the right in the second positive pulsed current phase after that and then back again to the left in the one following that and so forth. Therefore, it is not necessary for the current waveform to follow the waveform indicated. For example, the positive pulsed current phase may be composed of multiple pulsed current values; likewise the same thing applies for the positive basic current phase or the negative phase. Shoulders in the flanks are also possible; FIG. 2 shows the flanks as ideal flanks, but in reality the flanks have a certain slope. In addition, the sequences in which the phases follow one another may also be different than that shown here and another positive basic current phase may be inserted, for example. The deciding factor for the present invention is merely that the arc is deflected at least temporarily, but advantageously during the entire period of time during which the high positive pulsed current is applied. It is also possible not to deflect the arc in each positive pulsed current phase.

### LIST OF REFERENCE NUMERALS

1 welding torch
2 fusible electrode
3 right part of workpiece
4 left part of workpiece
5 imaginary line at the center of the undeflected arc
6 imaginary line at the center of the arc deflected to the right
7 imaginary line at the center of the arc deflected to the left

1. A method for arc joining, in particular for arc welding, whereby an arc burns between a workpiece and a fusible electrode at a processing site, such that an alternating current with at least one positive and at least one negative alternating current phase is applied between the electrode and the workpiece to generate the arc, such that the positive alternating current phase is divided into at least one positive pulsed current phase and at least one positive basic current phase and such that the arc is influenced at least temporarily by at least one external magnetic field, characterized in that the arc is deflected at least temporarily out of the center of the processing site by one or more external magnetic fields at least during every fifth, preferably during every second, especially preferably during each positive pulsed current phase, such that the arc is deflected into a first direction during a positive pulsed current phase and into a second direction which deviates from the first direction during the next positive pulsed current phase.

2. The method according to claim 1, characterized in that the first and second directions alternate continuously.

3. The method according to claim 1, characterized in that the first and second directions are opposite one another.

4. The method according to claim 1, characterized in that a transverse magnetic field is applied.

5. The method according to claim 1, characterized in that deposition rates of 6 to 15 kg/h are used.

6. The method according to claim 1, characterized in that deposition rates of 8 to 11 kg/h are used.

7. The method according to claim 1, characterized in that a gap formed by two edges in the workpiece is to be bridged.

8. The method according to claim 6, characterized in that the arc is always alternately deflected in the direction of one edge and the other edge.

9. The method according to claim 1, characterized in that root runs or one-sided joints are joined.

10. The method according to claim 1, characterized in that gases selected from the group consisting of argon, helium, carbon dioxide, oxygen, nitrogen, and mixtures thereof are used as the shielding gas.

11. The method according to claim 1, characterized in that workpieces made of steel and/or aluminum/aluminum alloys are processed.
